(19) United States
(12) Patent Application Publication
(10) Pub. No.: US 2017/0297701 A1
(43) Pub. Date: Oct. 19, 2017

(54) KITE WITH CONTROLLABLE TRAILING EDGE

(71) Applicant: Kite Power Systems Limited, Glasgow (GB)

(72) Inventors: Chris Hornzee-Jones, Brighton East Sussex (GB); William Hampton, Glasgow (GB)

(21) Appl. No.: 15/517,869

(22) PCT Filed: Oct. 7, 2015
(86) PCT No.: PCT/GB2015/052937

§ 371 Date: Apr. 7, 2017

(30) Foreign Application Priority Data
Oct. 7, 2014 (GB) 1417701.8

(51) Int. Cl. B64C 31/06; B64C 13/30; B64C 9/20; B64C 13/16; F03D 7/00; F03D 5/00

(52) U.S. Cl. CPC B64C 31/06; F03D 7/00; F03D 5/00; B64C 9/20; B64C 13/16; B64C 13/30

(57) ABSTRACT

A kite comprises: a wing; upper and lower flaps located along at least a portion of an edge of the wing that forms the trailing edge of the wing when the wing is active; a controller configured to generate control signals; and an actuator arrangement configured to change orientations of the upper and lower flaps relative to the wing based on the control signals generated by the controller.

### TECHNICAL FIELD

This specification relates to a kite and a method of operating a kite.

### BACKGROUND

Development work is currently being put into the use of high altitude kites for generating electrical power from atmospheric wind. There are many technical challenges involved in this development work. Some of these challenges relate to controlling a kite that is being flown at altitude and is subjected to high forces from interaction of the wind with the wing of the kite. Kites with ailerons are well known. However, arrangements to increase the drag provided by a kite are generally unsatisfactory for reasons of effectiveness or complexity.

The invention was made in this context.

### SUMMARY

A first aspect of the invention provides a kite comprising:
a wing;
upper and lower flaps located along at least a portion of an edge of the wing that forms the trailing edge of the wing when the wing is active;
a controller configured to generate control signals; and
an actuator arrangement configured to change orientations of the upper and lower flaps relative to the wing based on the control signals generated by the controller.

The controller may be configured to generate control signals to control the actuator arrangement in a first configuration to orientate the upper flap upwards relative to the wing and to orientate the lower flap downwards relative to the wing.

The controller may be configured to generate control signals to control the actuator arrangement in a second configuration to orientate the upper flap and to orientate the lower flap such that edges of the upper and lower flaps that are distal to the wing are at a substantially central position.

The controller may be configured to generate control signals to control the actuator arrangement in a third configuration to orientate the upper flap and to orientate the lower flap such that edges of the upper and lower flaps that are distal to the wing are below a substantially central position.

The controller may be configured to generate control signals to control the actuator arrangement in a fourth configuration to orientate the upper flap and to orientate the lower flap such that edges of the upper and lower flaps that are distal to the wing are above a substantially central position.

Each of the upper and lower flaps may comprise plural sections each having associated therewith a respective actuator. The plural sections of the flaps may be contiguous.

The controller may be configured to provide control signals to the actuator arrangement to control actuators of adjacent sections of the upper and lower flaps to provide substantially the same configuration of the flaps along the lengths of the flaps.

The controller may be configured to provide control signals to the actuator arrangement to control actuators of adjacent sections of the upper and lower flaps to provide different configurations for the flaps at different positions along the lengths of the flaps.

The controller may be configured to provide control signals to the actuator arrangement to control actuators of adjacent sections of the upper and lower flaps to provide a different configurations for the flaps at one side of the kite compared to the other side.

The controller may be configured to provide control signals to the actuator arrangement to control actuators of adjacent sections of the upper and lower flaps to provide substantially one configuration of the flaps at a central position along the lengths of the flaps and to provide a different configuration for the flaps at non-central positions along the length of the flaps.

The upper and lower flaps may be hingedly connected to the edge of the wing that forms the trailing edge of the wing when the wing is active. The hinged connection of the upper flap to the wing may be separated from the hinged connection of the lower flap to the wing in a direction transverse to the length dimension of the trailing edge of the wing.

Each flap may comprise a flexible sheet material supported by rigid members.

Each flap may have a length that is at least 75% of the length of the trailing edge of the wing. Each flap may have a length that is at least 90% of the length of the trailing edge of the wing. Each flap may have a length that is substantially the same as the length of the trailing edge of the wing.

Alternatively, each flap may be generally centrally located on the trailing edge of the wing, and the wing may be absent of active flaps at end portions thereof

The kite may comprise left and right tip portions, each of the left and right tip portions comprising upper and lower flaps located at a tip of the trailing edge of the wing.

The upper flap may have substantially the same length as and be substantially contiguous with the lower flap.

A second aspect of the invention provides an electrical power generating system comprising a kite as above.

A third aspect of the invention provides a method of operating a kite comprising a wing having upper and lower flaps located along at least a portion of an edge of the wing that forms the trailing edge of the wing when the wing is active, the method comprising:
a controller controlling an actuator arrangement to change orientations of the upper and lower flaps relative to the wing.

### BRIEF DESCRIPTION OF THE DRAWINGS

Embodiments of the invention will now be described, by way of example only, with reference to the accompanying drawings, in which:

FIG. 1 is a cross-section through a kite according to embodiments of the present invention;

FIG. 2 is a schematic diagram of certain components of the FIG. 1 kite, according to embodiments of the invention;

FIG. 3 is an isometric view of the FIG. 1 kite, according to embodiments of the invention;

FIG. 4 is a plan view showing some components of the FIG. 1 kite, according to embodiments of the invention;

FIG. 5 is an isometric view of a flap orientating mechanism suitable for fitting to a kite according to some embodiments of the invention;

FIG. 6 is a side view of the flap orientating mechanism in a first position;

FIG. 7 is an isometric view of the flap orientating mechanism in a second position;

FIG. 8 is an isometric view of an arrangement comprising the flap orientating mechanism with a frame component of a wing and aerodynamic members that constitute flaps and are orientated by the flap orientating mechanism in use; and

FIG. 9 provides further details of the arrangement of FIG. 8.

FIG. 10 provides further details of the arrangement of FIG. 8.

### DETAILED DESCRIPTION

In brief, embodiments of the invention provide a kite that includes a wing and upper and lower flaps located on the trailing edge of the wing and controllable so as to be moved such that the orientation of the flaps relative to the wing is adjusted. The arrangement can be called a double split flap arrangement. It may also be called a deceleron, a split aileron or a drageron. Control of the flaps in this way affects the flight characteristics of the wing, and by suitable control of the flaps this can be used to the advantage of the use of the kite to generate electricity from the wind. By adjusting the orientation of the flaps relative to the wing in opposite directions (either locally or across the width of the kite), the drag provided by the wing can be adjusted, and increased drag can be caused to be provided with the effect of slowing forward movement of the kite. By adjusting the orientation of the flaps differently, the lift provided by the wing can be changed, either locally or across the whole or most of the length dimension of the trailing edge of the wing. Also, the pitch of the wing can be adjusted by adjusting the orientation of the flaps relative to the wing. Furthermore, controlling the flaps to provide more drag on one side of the kite than on the other side allows the kite to be steered. Additionally, control of the flaps can allow the stability of flight of the kite to be adjusted, to the benefit of operation of the system including the kite. Notably, by suitable control aerodynamic characteristics can be influenced independently from others, so that for instance drag can be provided without changing lift or pitching moment.

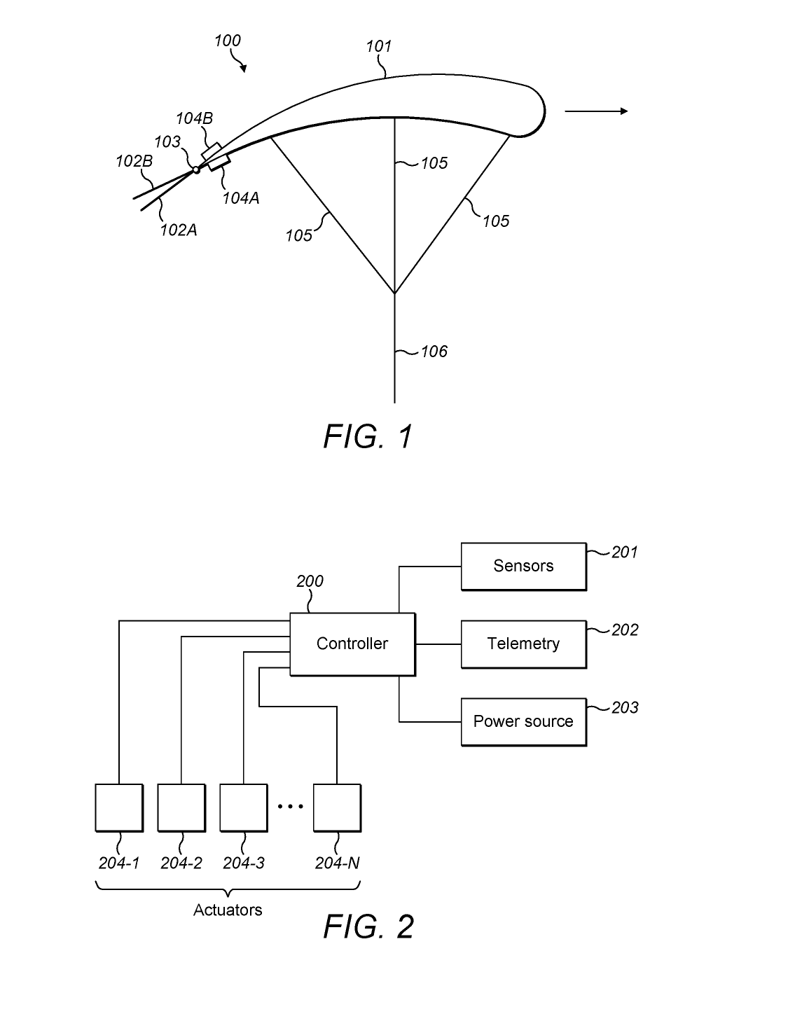

Some embodiments will now be described in detail, starting with reference to FIG. 1.

FIG. 1 shows a kite 100 according to various embodiments of the invention in cross-section. The kite 100 includes a wing 101 that is shaped such that when caused to be active by the presence of wind it moves forwards in the direction indicated by the arrow. As such, the part of the wing that is rightmost shown in the drawing is the leading edge of the wing 101, and the trailing edge is the edge at the leftmost side of the Figure. The wing 100 is connected to a tether 106 by a number of bridles 105.

Attached to the trailing edge of the kite is a lower flap 102A. The lower flap 102A is attached to the wing 101 by a hinge 103. A lower flap actuator device 104A is attached to the kite 100, in this particular example is attached to the wing 101, and is configured to adjust an orientation of the lower flap 102A relative to the wing 100, in particular by rotating the lower flap 102A around the hinge 103.

Also attached to the trailing edge of the kite is an upper flap 102B. The upper flap 102B is attached to the wing 101 by the or another hinge 103. An upper flap actuator device 104B is attached to the kite 100, in this particular example is attached to the wing 101, and is configured to adjust an orientation of the upper flap 102B relative to the wing 100, in particular by rotating the upper flap 102B around the hinge 103. A common hinge 103 can be used for the upper and lower flaps 102A and 102B because the trailing edge of the wing 101 has a relatively small height dimension.

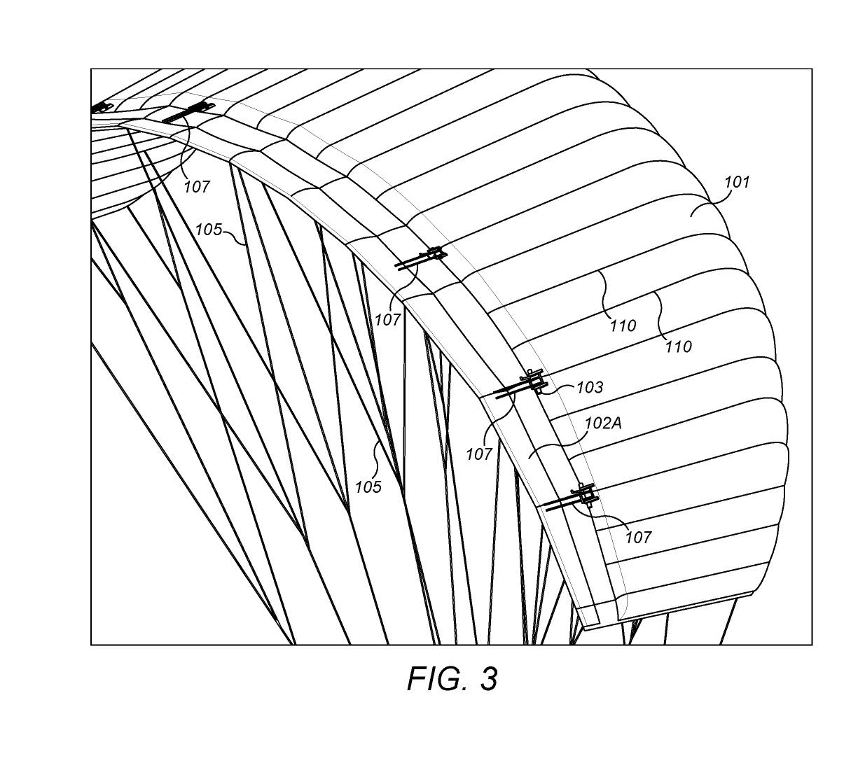

FIG. 2 shows a number of components of the kite that are not visible in FIG. 1. These include a controller 200, which may for instance be a microcontroller or a more sophisticated processor arrangement. The controller includes processing means that are programmed with computer code so as to achieve various functions and provide various features, as are described below.

The controller 200 is connected to a number of other components, including one or more sensors 201. The sensors 201 may for instance include navigation sensors, which may detect parameters such as the location of the kite 100, its orientation, its speed and/or direction of travel and/or the relative speed between the wing 101 and the wind.

The controller 200 is also coupled to a telemetry module 202. The telemetry module 202 allows communication between the controller 200 (and the kite 100 in general) and a ground station (not shown) which may or may not be where the tether 106 is attached to the ground. The ground station includes electrical generation equipment for generating electricity from the kite 100 pulling out the tether 106.

The kite 100 also includes a power source 203. This may for instance be a battery, super capacitor or other charge storage device. Alternatively, it may be a power supply that is coupled by electrically conducting cables to a power supply located at the ground station.

The controller 200 is also connected directly to a number of actuators, which are illustrated in FIG. 2 at 204-1, 204-2, 204-3 . . . 204-n. The actuators 104A and 104B of FIG. 1 each constitute one of the actuators 204 of FIG. 2.

Operation of the controller 200, particularly in relation to the actuators 204, will be apparent with reference to the below description.

FIG. 3 shows some details of the kite 100 that are not visible in FIG. 1. In particular, wing support seams 110 of the wing 101 are visible in FIG. 3. The wing support seams 110 divide the wing into a number of segments in the lengthwise dimension of the wing 101. Each of the segments defined by the wing support seams 110 is inflated, so as to provide the wing 101 with the desired shape. The segments are not sealed from one another, and air is able to pass between them.

Although only part of the kite 100 is visible in FIG. 3, it will be seen that the lower flap 102A and the upper flap 102B each extend for the whole of the length of the trailing edge of the wing 101. In other embodiments, the flaps 102A and 102B have lengths that are different to the length dimension of the trailing edge of the wing 101, for instance they may instead extend for a lesser amount, e.g. 50, 75 or 90% of the length of the trailing edge. Where the upper and lower flaps 102A and 102B do not extend for the whole width of the kite 100, it may be the middle section of the kite 100 that is absent the flaps, or it may be the ends that are absent the flaps. An elongate flap 102A, 102B may be divided into plural sections that have a gap in between.

FIG. 3 shows the hinge 103 between the upper flap 102B and the wing 101. The hinge takes the form of connection of a material forming the wing 101 and the material forming the upper flap 102B. The hinge 103 may be continuous, in that the upper flap 102B and the wing 101 may be continuously connected across the entire length of the trailing edge of the wing 101. As will be seen below, there is a hinged connection also between struts that support the flaps and the trailing edge of the wing 101.

The upper flap 102B is provided with a number of flap struts 107. These struts extend substantially in the direction of travel of the kite 100 (as illustrated by the arrow in FIG. 1), and thus extends transversely to the length of the upper flap 102B. The struts 107 extend at least from the hinge 103 that connects the upper flap 102B to the wing 101, and extend most or all of the way to the rear edge of the upper flap 102B. The struts 107 are rigid, in that they are resistant to bending. The material of the upper flap 102B itself may be flexible. The provision of the flap struts 107 allows the orientation of the upper flap 102B relative to the wing 101 to be adjusted, using the actuator device 104 and the actuators 204. Although not visible in the Figure, a corresponding arrangement is provided in respect of the lower flap 102A.

The kite as illustrated in FIGS. 1 and 3 can be described as a hybrid kite because the wing 101 is air filled and includes a frame (not shown). The frame of the wing 101 may be formed of rigid material, or it may be provided by an inflated member or series of members (e.g. tubes), that together provide a semi-rigid frame. The inflation of the frame may be independent of the influx of air into the wing 101 of the kite 100 as it is flown. It will be appreciated that the kite may be of any other suitable form, for instance it may be of the flexible sail type, of the stiffened flexible sail type, of the rigid wing type, of the biplane or multiplane type etc.

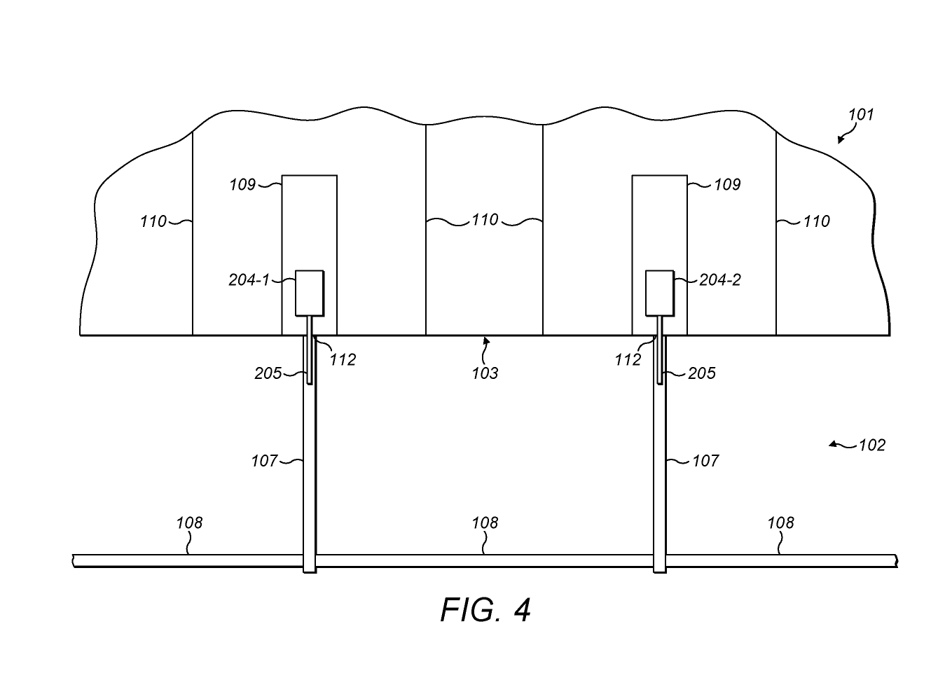

FIG. 4 is a plan view showing some detail of the upper flap 102B and its connection to the wing 101. Some of the features shown in FIG. 4 are not shown in FIG. 3. The flap struts 107 are shown as being connected at strut hinges 112 to actuator mounts 109, that are provided on the wing 101. The actuator mounts 109 in this example take the form of rigid plates that are provided on the exterior surface of the wing 101. The strut hinge 112 that hingedly connects the actuator mounts 109 to the flap strut 107 may take any suitable form. The primary function of the strut hinges 112 is to allow hinged movement of the actuator mounts 109 relative to the flap struts 107 and to prevent or restrict movement of the flap strut 107 away from the actuator mounts 109.

The actuator mount 109 supports the actuators 204-1 and 204-2 in a one-to-one relationship. Each actuator 204 is coupled to its respective flap strut 107 by a respective strut movement linkage 205. This allows the actuator 204 to effect movement of the flap strut 107 around the strut hinge 112, thereby causing a change in the orientation of the upper flap 102B relative to the wing 101. An example form for the actuators 204 and the strut movement linkage 205 is provided below.

Flap supports 108 are provided at the trailing edge of the upper flap 102B. Each support 108 is connected at its ends to different ends of adjacent struts 107. The connections are flexible, to allow the distance between the ends of the struts to be varied as adjacent struts are oriented differently. The supports help to maintain a generally planar shape for each section of the upper flap 102B, as defined by adjacent struts 107. The supports 108 may for instance be carbon rods, aluminum rods etc. The supports 108 may alternatively be omitted.

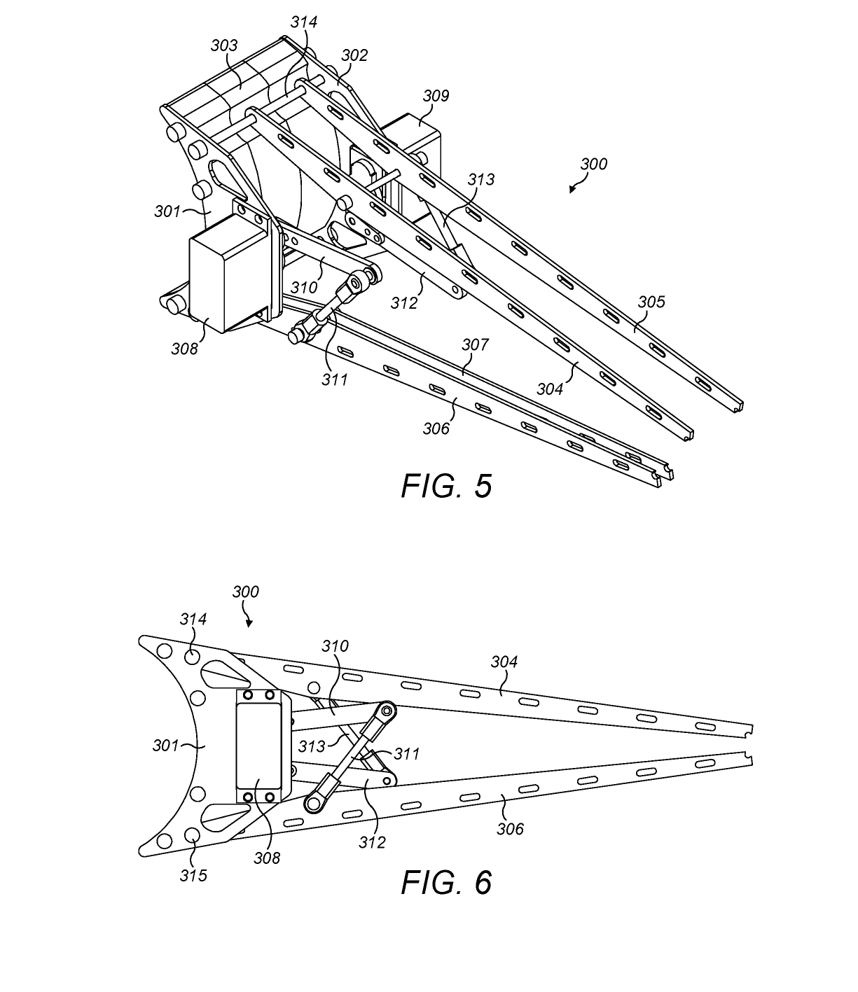

A flap orientating mechanism 300 that is usable to provide controllable upper and lower flaps 102A, 102B will now be described with reference to FIGS. 5 to 7.

The flap orientating mechanism 300 includes a left bracket 301 and a right bracket 302, which are separated by a spacer 303. The brackets 301 and 302 provide a support for other components of the flap orientating mechanism 300 and facilitate connection of the flap orientating mechanism 300 to the wing 101 of the kite 100.

In respect of the upper flap 102B, the flap orientating mechanism 300 includes an upper left strut 304 and an upper right strut 305. The upper struts 304, 305 are hinged, in particular by being mounted on a rod 314 that is supported by the brackets 301 and 302. The hinging allows the upper struts 304, 305 to swivel upwards and downwards, relative to the width dimension of the kite 100. The nature of the hinging arrangement is such that the upper struts 304, 305 are restricted from movement laterally, and are restricted from twisting. The upper struts 304, 305 are connected together and so swivel up and down together. They may be replaced by a single strut, but the use of two struts provides increased strength and increased resistance to movement other than swiveling movement around the hinge 314.

In respect of the lower flap 102A, the flap orientating mechanism 300 includes a lower left strut 306 and a lower right strut 307. The lower struts 306, 307 are hinged, in particular by being mounted on another rod 315 that is supported by the brackets 301 and 302. The hinging allows the lower struts 306, 307 to swivel upwards and downwards. The nature of the hinging arrangement is such that the lower struts 306, 307 are restricted from movement laterally, and are restricted from twisting. The lower struts 306, 307 are connected together and so swivel up and down together. They may be replaced by a single strut, but the use of two struts provides increased strength and increased resistance to movement other than swiveling around the hinge 315.

The hinge 314 for the upper struts 305, 304 is located relatively close to the location of the connection between the upper flap 102B and the wing 101. Thus, the upper struts 304, 305 define the location of the upper flap 102B. The same applies to the hinge 315 and the lower struts 306, 307 with respect to the lower flap 102A.

The hinges 314, 315 for the upper and lower struts 304-307 are separated in the vertical direction by a significant distance, in particular more than half the thickness of the wing 101 at the trailing edge, preferably almost the whole thickness. The same applies to the FIG. 1 kite 100, although in that case the wing 101 has very little height at the trailing edge.

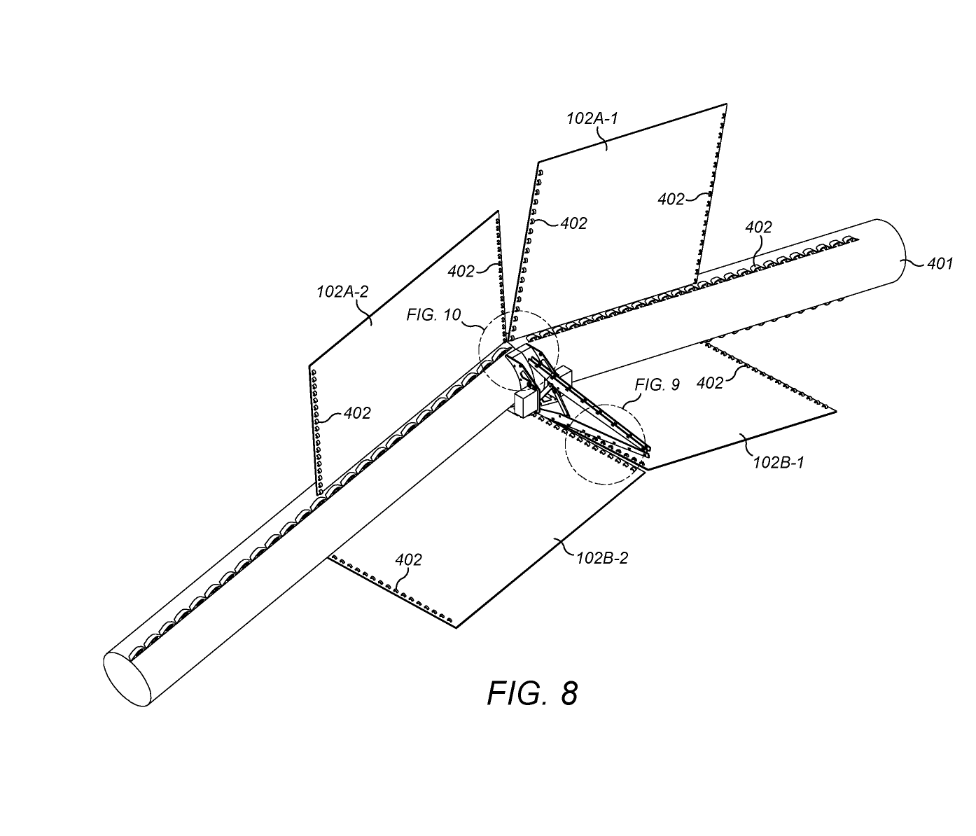

The flap orientating mechanism 300 is shown installed on a trailing edge of the wing 101 in FIG. 8. In particular, the Figure shows a frame component 401 of the wing 101 that defines the trailing edge in use. The frame component 401 here is generally cylindrical, which is particularly convenient for an inflatable frame, although it may take any suitable form. If the frame component 401, or other solid part of the trailing edge of the wing 100, has a different shape then the flap orientating mechanism 300 is shaped accordingly. Here, the brackets 301, 302 of the flap orientating mechanism 300 are shaped to fit onto the exterior surface of the cylindrical frame component 401. The frame component 401 as shown is bent in the middle, and comprises two sections that are connected together.

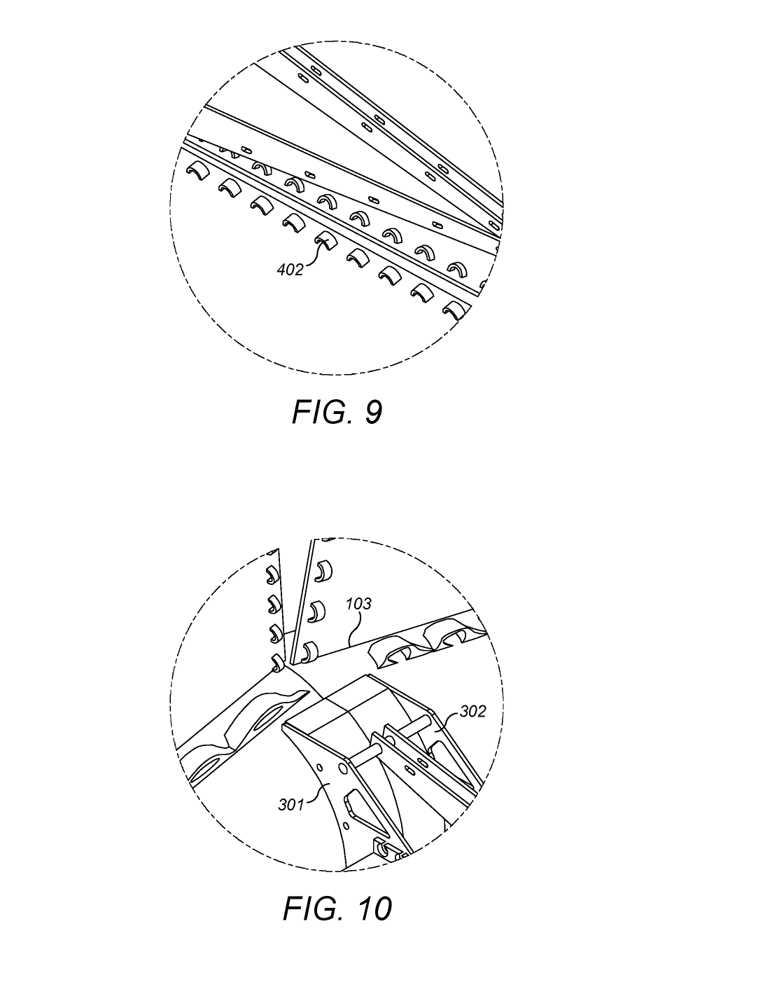

FIG. 8 also shows the attachment of upper flap sections 102A-1 and 102A-2 to the upper struts 304, 305 and to the wing 101. The upper flap sections 102A-1 and 102A-2 comprise sheet material, which may be substantially rigid or may be flexible. The upper flap sections 102A-1 and 102A-2 are provided with loops 402 (best seen in FIG. 9) that allow them to be fastened to the upper struts 304, 305. Connector features, e.g. loops, on the wing 101 allow connection of the flap orienting mechanism 300 to the wing. This is best seen in FIG. 10.

Lower flap sections 102B-1 and 102B-2 are similarly configured and connected to the lower struts 306, 307 and to the wing 101.

A lower strut actuator 308 is configured to orientate the lower struts 306, 307 based on control signals from the controller 200. In particular, the lower strut actuator 308 is operable to swivel the lower struts 306, 307 upwards and downwards as controlled by the controller. Advantageously, the lower strut actuator 308 is configured to move the lower struts 306, 307 to a position indicated by the control signals, instead of moving by an amount specified by the control signals. This helps to ensure that the lower flap 102A is moved to a desired position when the lower strut actuator 308 is controlled to move the flap 102A. The position of the lower struts 306, 307 is controlled relative to the wing 101, in particular relative to the actuator mounts 109.

In the illustrated arrangement, the lower strut actuator 308 is configured to swivel the lower struts 306, 307 upwards and downwards as controlled by the controller through a linking arrangement comprising a lower drive arm 310 and a lower coupling arm 311. The lower strut actuator 308 here may be a servo. The lower drive arm 310 is connected at one end to the lower strut actuator 308 and is connected at the other end by a linkage to one end of the lower coupling arm 311. The other end of the lower coupling arm 311 is connected to the lower struts at a location separated from the location of the hinge 315. The lower strut actuator 308 rotates one end of the lower drive arm 310 under control of the controller. The resulting displacement of the other end of the lower drive arm is communicated to displacement of the lower struts 306, 307 by the lower coupling arm 311. Thus, the orientation of the lower struts 306, 307 relative to the wing 101 is adjusted by the lower strut actuator 308 under control of the controller 200.

An upper strut actuator 309 is coupled to the upper struts 304, 305 by an upper drive arm 312 and an upper coupling arm 313 and is configured in substantially the same way and operates in substantially the same manner as the corresponding lower arrangement.

In the illustrated arrangement, the upper struts 304, 305 are movable independently of the lower struts 306, 307, under control of the controller 200. This provides a number of useful options for control of the kite 100, as is described below.

At the location of the flap orientating mechanism 300, there are four possible configurations for the upper and lower flaps 102A, 102B at a given moment in time. The fourth configuration is of particular interest and significance.

In a first configuration, the actuators 308 and 309 are controlled to locate the upper and lower struts 304-307 so as to have their distal ends touching or approximately touching at a location that is substantially central with respect to the flap orientating mechanism 300, i.e. in the position shown in FIG. 6. In this configuration, the upper and lower flaps 102A and 102B form an aerodynamically neutral extension to the wing 101 and do not contribute significantly to lift or drag.

In a second configuration, the actuators 308 and 309 are controlled to locate the upper and lower struts 304-307 so that they are both directed more downwardly than they are in the first configuration. Advantageously in the second configuration the distal end of the upper flap 102B touches or is close to touching an uppermost surface of the lower flap 102A at a location that is below a central position with respect to the flap orientating mechanism 300, i.e. downwards from the position shown in FIG. 6. Because of the separation between the axes of rotation of the upper and lower flaps 102A and 102B, the upper flap 102B is oriented downwards to a greater extent that the lower flap 102A. With no separation between the axes of rotation, there is little or no difference in orientation in this configuration.

In the second configuration, the upper and lower flaps 102A and 102B contribute to pitching the front of the associated part of the wing 101 downwards, i.e. pitching the kite clockwise for the orientation shown in FIG. 1. This can be called a positive flap configuration. The extent of the effect depends on the extent to which the upper and lower flaps 102A and 102B are oriented downwards. This configuration provides increased lift and increased drag, compared to the first configuration.

In a third configuration, the actuators 308 and 309 are controlled to locate the upper and lower struts 304-307 so that they are both directed more upwardly than they are in the first configuration. Advantageously in the second configuration the distal end of the lower flap 102B touches or is close to touching the lowermost surface of the upper flap 102A at a location that is above a central position with respect to the flap orientating mechanism 300, i.e. upwards from the position shown in FIG. 6. Because of the separation between the axes of rotation of the upper and lower flaps 102A and 102B, the upper flap 102B is oriented upwards to a lesser extent that the lower flap 102A. With no separation between the axes of rotation, there is little or no difference in orientation in this configuration.

In the third configuration, the upper and lower flaps 102A and 102B form a flap that provide the wing with a reflex camber and contribute to pitching the front of the associated part of the wing 101 upwards, i.e. pitching the kite anticlockwise for the orientation shown in FIG. 1. This can be called a negative flap configuration. The extent of the pitching effect depends on the extent to which the upper and lower flaps 102A and 102B are oriented upwards. This configuration provides decreased lift compared to the first configuration. This configuration may provide decreased or increased drag, compared to the first configuration, depending on a number of factors.

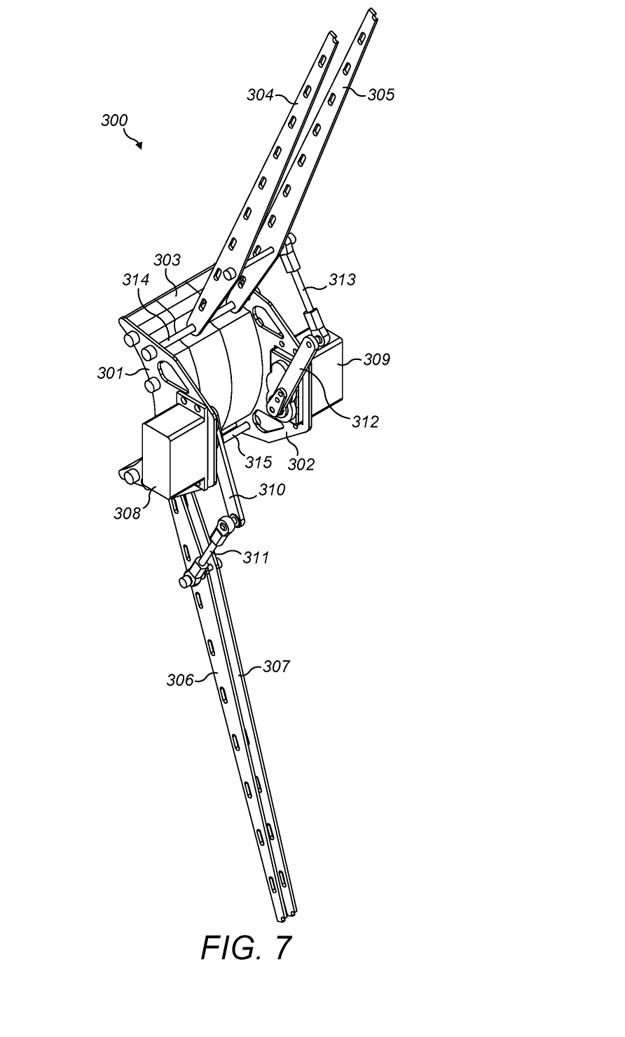

In a fourth configuration, the actuators 308 and 309 are controlled to locate the upper and lower struts 304-307 so as to have their distal ends separated from one another by a significant distance. The configuration of the flap orientating mechanism 300 in the fourth configuration is shown in FIG. 7. Here, the upper flap 102B is oriented upwards and the lower flap 102A is oriented downwards. In this configuration, the upper and lower flaps 102A and 102B together provide a significant drag force, and thus resist forward movement of the kite 100. By controlling the flap orientating mechanism 300 such that the upper and lower flaps 102A and 102B are oriented by the same amount, the drag is provided without any effect on the pitch of the kite 100, i.e. without pitching the kite 100 downwards or upwards. This configuration can be called a high drag configuration.

Providing drag slows forward movement of the kite 100. This can be useful in preventing overspeed of the kite 100, which can be particularly advantageous when the kite is being retracted towards the ground station.

As with the arrangement shown in FIG. 3, plural flap orientating mechanisms 300 are spaced along the trailing edge of the wing 101. Each controls the location of a different part of the upper flap 102B and a corresponding part of the lower flap 102A. Each of the flap orientating mechanisms 300 is controllable independently of the others, and different flap orientating mechanisms 300 can cause the associated part of the flap 102A, 102B to be in an orientation with respect to the wing 101 that is different to an orientation provided by an adjacent flap orientating mechanism 300.

The controller 200 is configured in some modes to provide substantially the same configuration along the length of the upper and lower flaps 102A and 102B. Where the kite 100 is flying with relatively high lift, to generate power at the ground station, the controller 200 may be configured to provide the kite 100 with the first configuration described above for substantially the entire length of the flaps 102A and 102B. Where the kite 100 is required to be slowed in its forward movement, the controller 200 is configured to provide the kite 100 with the fourth configuration for substantially the whole length of the flaps 102A and 102B.

The controller 200 is configured also in other modes to provide different configurations at different locations along the length of the flaps 102A and 102B.

In a first such mode, the controller 200 is configured to provide the third configuration (negative flap) across the whole or substantially all of the length of the flaps 102A and 102B. This can provide a reflex camber for the whole or a significant proportion of the width of the wing 101 of the kite 100. In this mode, the kite 100 can be made to provide relatively low levels of lift, which can be particularly useful in controlling tension in the tether when launching or landing/docking the kite 100 in high speed wind conditions.

In a second such mode, the controller 200 is configured to provide the second configuration (positive flap) at a central position of the kite 100 and either the first configuration (neutral flap) or the fourth configuration (high drag) at the left and right sides of the kite 100. This allows the kite 100 to be steered, through suitable adjustment of the degree to which the flaps 102A and 102B are oriented into the fourth configuration (which determines the amount of drag provided) at the appropriate side of the kite 100. For instance, controlling the upper and lower flaps 102A and 102B to provide the fourth, high drag, configuration, at the right side of the kite but not at the left side causes the kite to be steered to the right, in the sense that it rotates relative to the axis of the tether 106. With or without steering, this mode however provides a high lift configuration. As such, it may be especially useful for launching and landing/docking in light winds (low wind speed conditions).

In a third such mode, the controller 200 is configured to provide the third configuration (negative flap) at a central position of the kite 100 and the second configuration (positive flap) at the left and right sides of the kite 100. In this mode, the kite 100 can be made to be pitch neutral, that is neither to pitch down nor up. In this mode the kite can also be made to be lift neutral. However, the drag is increased compared to the first configuration.

In a fourth mode, the fourth configuration (high drag) is used to steer the kite when applied to only a part of the length of the trailing edge of the wing 101 but without providing the second (positive flap) configuration at the central part of the trailing edge. For instance, controlling the upper and lower flaps 102A and 102B to provide the fourth, high drag, configuration, at the right side of the kite but not at the left side causes the kite to be steered, in the sense that it rotates relative to the axis of the tether 106.

In other embodiments, part of the edge of the wing is active (dynamically controllable) and part of the edge of the wing is static (fixed, not controllable). Other features from the above embodiments are present in these other embodiments where appropriate.

In a first such embodiment, a central part of the wing is active, and tips of the wings are active. A first portion between the active left tip portion and the active central portion is static (fixed) and a second portion between the active right tip portion and the active central portion is static. The active tip portions may each comprise about 10% of the width of the wing, or more generally between 5 and 15% of the width of the wing. The central portion may comprise about 25% of the width of the wing, or more generally 20-30% or more generally 10-40% of the width of the wing. The upper and lower flaps 102A and 102B may comprise a flexible connection between active and static portions, or there may be a discontinuity at the edge at the junction between active and static portions. The static and active portions may be longer in chord in that they extend over a greater distance in the fore and aft direction of the kite.

This kite is operable in a number of different modes.

In a first mode, the controller 200 is configured to provide the fourth configuration (high drag) at the central position of the kite 100 and either the first configuration (neutral flap) or the fourth configuration (high drag) at the left and right tip portions of the kite 100. The static portions in between the active portions are substantially neutral.

In a second such mode, the controller 200 is configured to provide the second configuration (positive flap) at a central position of the kite 100 and either the first configuration (neutral flap) or the fourth configuration (high drag) at the left and right tips of the kite 100. This allows the kite 100 to be steered, through suitable adjustment of the degree to which the flaps 102A and 102B are oriented into the fourth configuration (which determines the amount of drag provided) at the appropriate side of the kite 100. For instance, controlling the upper and lower flaps 102A and 102B to provide the fourth, high drag, configuration, at the right side of the kite but not at the left side causes the kite to be steered to the right, in the sense that it rotates relative to the axis of the tether 106. With or without steering, this mode however provides a high lift configuration. As such, it may be especially useful for launching and landing/docking in light winds (low wind speed conditions).

In a third mode, the fourth configuration (high drag) is used to steer the kite when applied to the tips of the trailing edge of the wing 101 but without providing the second (positive flap) configuration at the central portion of the trailing edge. For instance, controlling the upper and lower flaps 102A and 102B to provide the fourth, high drag, configuration, at the right tip of the kite but not at the left tip causes the kite to be steered, in the sense that it rotates relative to the axis of the tether 106.

In a fourth mode, the controller 200 is configured to provide the third configuration (negative flap) at the central portion of the kite 100 and the fourth configuration (high drag) at the left and right tips of the kite 100. This provides stability in the kite from the reflex configuration at the middle. The kite is then steered whilst in the high stability position by suitable control of the upper and lower flaps 102A and 102B to provide the fourth, high drag, configuration, at the right tip of the kite and at the left tip of the kite.

In a fifth such mode, the controller 200 is configured to provide the third configuration (negative flap) at the central portion of the kite 100 and the second configuration (positive flap) at the left and right tips of the kite 100. In this mode, the kite 100 can be made to be pitch neutral, that is neither to pitch down nor up. In this mode the kite can also be made to be lift neutral. However, the drag is increased compared to the first configuration.

In a second such embodiment, a central part of the wing is active, and tips of the wings are static (fixed). The central portion may comprise about 25% of the width of the wing, or more generally 20-30% or more generally 10-60% of the width of the wing. The upper and lower flaps 102A and 102B may comprise a flexible connection between active central portion and the adjoining static portions, or there may be a discontinuity at the edge at the junction between the central active portion and the static portions. The static and active portions may be longer in chord in that they extend over a greater distance in the fore and aft direction of the kite.

This kite is operable in a number of different modes.

In a first mode, the controller 200 is configured to provide the fourth configuration (high drag) at the central position of the kite 100. The static portions either side of the active portions are substantially neutral. This provides drag on the kite without steering.

In a second such mode, the controller 200 is configured to provide the second configuration (positive flap) at the central position of the kite 100. Steering of the kite is achieved other than by control of the flaps of the trailing edge. This mode provides a high lift configuration. As such, it may be especially useful for launching and landing/docking in light winds (low wind speed conditions).

In a third such mode, the controller 200 is configured to provide the third configuration (negative flap) at the central portion of the kite 100. This provides stability to the wing in flight.

In a third such embodiment, a central part of the wing is static (fixed), and tips of the wings are active. The active tip portions may each comprise about 10% of the width of the wing, or more generally between 5 and 15% of the width of the wing. The upper and lower flaps 102A and 102B may comprise a flexible connection between active and static portions, or there may be a discontinuity at the edge at the junction between active and static portions. The static and active portions may have different depths, for instance the active portions may be deeper, in that they extend over a greater distance in the fore and aft direction of the kite.

This kite is operable in a number of different modes.

In a first mode, the controller 200 is configured to provide the fourth configuration (high drag) at the left and right tip portions of the kite 100. The static portions in between the active tip portions are substantially neutral. This allows the kite 100 to be steered, through suitable adjustment of the degree to which the flaps 102A and 102B are oriented into the fourth configuration (which determines the amount of drag provided) at the appropriate side of the kite 100. For instance, controlling the upper and lower flaps 102A and 102B to provide the fourth, high drag, configuration, at the right side of the kite but not at the left side causes the kite to be steered to the right, in the sense that it rotates relative to the axis of the tether 106.

With or without steering, this provides increased lift to the flaps 102A and 102B are provided in the fourth configuration in the positive direction, or increased stability if in the negative direction.

In a second mode, the controller 200 is configured to provide a neutral configuration at both the left and right tip portions of the kite 100, to effect normal wing behavior.

Instead of servos, the actuators 104, 204, 308, 309 may take any suitable form. For instance, an actuator may include an electric stepper motor. It may alternatively include an electric motor and a rack and pinion or other mechanism for converting rotation into linear displacement. The actuators may alternatively be pneumatic or hydraulic actuators. A pneumatic actuator may for instance include a piston or an inflatable bladder to cause movement of the associated flap.

Unless otherwise stated, features of the FIGS. 5-7 arrangement are present in the FIGS. 1, 3 and 4 arrangement. Also, features of the FIGS. 1, 3 and 4 arrangement are present in the FIGS. 5-7 arrangement unless otherwise stated.

1. A kite comprising:
a wing;
upper and lower flaps located along at least a portion of an edge of the wing that forms the trailing edge of the wing when the wing is active;
a controller configured to generate control signals; and
an actuator arrangement configured to change orientations of the upper and lower flaps relative to the wing based on the control signals generated by the controller.

2. A kite as claimed in claim 1, wherein the controller is configured to generate control signals to control the actuator arrangement in a first configuration to orientate the upper flap upwards relative to the wing and to orientate the lower flap downwards relative to the wing.

3. A kite as claimed in claim 1 wherein the controller is configured to generate control signals to control the actuator arrangement in a second configuration to orientate the upper flap and to orientate the lower flap such that edges of the upper and lower flaps that are distal to the wing are at a substantially central position.

4. A kite as claimed in 1, wherein the controller is configured to generate control signals to control the actuator arrangement in a third configuration to orientate the upper flap and to orientate the lower flap such that edges of the upper and lower flaps that are distal to the wing are below a substantially central position.

5. A kite as claimed in 1, wherein the controller is configured to generate control signals to control the actuator arrangement in a fourth configuration to orientate the upper flap and to orientate the lower flap such that edges of the upper and lower flaps that are distal to the wing are above a substantially central position.

6. A kite as claimed in 1, wherein each of the upper and lower flaps comprise plural sections each having associated therewith a respective actuator.

7. A kite as claimed in claim 6, wherein the plural sections of the flaps are contiguous.

8. A kite as claimed in claim 6, wherein the controller is configured to provide control signals to the actuator arrangement to control actuators of adjacent sections of the upper and lower flaps to provide substantially the same configuration of the flaps along the lengths of the flaps.

9. A kite as claimed in claim 6, wherein the controller is configured to provide control signals to the actuator arrangement to control actuators of adjacent sections of the upper and lower flaps to provide different configurations for the flaps at different positions along the lengths of the flaps.

10. A kite as claimed in claim 6, wherein the controller is configured to provide control signals to the actuator arrangement to control actuators of adjacent sections of the upper and lower flaps to provide a different configurations for the flaps at one side of the kite compared to the other side.

11. A kite as claimed in claim 6, wherein the controller is configured to provide control signals to the actuator arrangement to control actuators of adjacent sections of the upper and lower flaps to provide substantially one configuration of the flaps at a central position along the lengths of the flaps and to provide a different configuration for the flaps at non-central positions along the length of the flaps.

12. A kite as claimed in claim 1, wherein the upper and lower flaps are hingedly connected to the edge of the wing that forms the trailing edge of the wing when the wing is active.

13. (canceled)

14. A kite as claimed in claim 1, wherein each flap comprises a flexible sheet material supported by rigid members.

15. A kite as claimed in claim 1, wherein each flap has a length that is at least 75% of the length of the trailing edge of the wing, or at least 90% of the length of the trailing edge of the wing.

16. (canceled)

17. A kite as claimed in 1, wherein each flap has a length that is substantially the same as the length of the trailing edge of the wing.

18. A kite as claimed in claim 1, wherein the upper flap has substantially the same length as and is substantially contiguous with the lower flap.

19. A kite as claimed in claim 1, wherein each flap is generally centrally located on the trailing edge of the wing, and wherein the wing is absent of active flaps at end portions thereof.

20. A kite as claimed in claim 1, comprising left and right tip portions, each of the left and right tip portions comprising upper and lower flaps located at a tip of the trailing edge of the wing.

21. An electrical power generating system including a kite comprising:
a wing;
upper and lower flaps located along at least a portion of an edge of the wing that forms the trailing edge of the wing when the wing is active;
a controller configured to generate control signals; and
an actuator arrangement configured to change orientations of the upper and lower flaps relative to the wing based on the control signals generated by the controller.

22. A method of operating a kite comprising a wing having upper and lower flaps located along at least a portion of an edge of the wing that forms the trailing edge of the wing when the wing is active, the method comprising:
a controller controlling an actuator arrangement to change orientations of the upper and lower flaps relative to the wing.
